(19) United States
(12) Patent Application Publication
(10) Pub. No.: US 2003/0115350 A1
(43) Pub. Date: Jun. 19, 2003

(54) System and method for efficient handling of network data

(75) Inventors: Oran Uzrad-Nali, Sunnyvale, CA (US); Somesh Gupta, San Jose, CA (US)

Correspondence Address: SUGHRUE MION, PLLC, 2100 PENNSYLVANIA AVENUE, N.W., WASHINGTON, DC, 20037, US

(73) Assignee: SILVERBACK SYSTEMS, INC.

(21) Appl. No.: 10/014,602

(22) Filed: Dec. 14, 2001

(51) Int. Cl. G06F 15/16; G06F 17/30

(52) U.S. Cl. 709/231; 707/10; 709/219

(57) ABSTRACT

A networked system comprising a host computer. A data streamer is connected to the host computer. The data streamer is capable of transferring data between the host and networked resources using a memory location without moving the data within the memory location. A communication link connects the data streamer and networked resources.

### I. DESCRIPTION

I.A. Field

This disclosure teaches novel techniques related to managing commands associated with upper layers of a network management system. More specifically, the disclosed teachings relate to the efficient handling of application data units transmitted over network systems.

I.B. Background

There has been a significant increase in the amount of data transferred over networks. To facilitate such a transfer, the demand for network storage systems that can store and retrieve data efficiently has increased. There have been several conventional attempts at removing the bottlenecks associated with the transfer of data as well as the storage of data in the network systems.

Several processing steps are involved in creating packets or cells for transferring data over a packetized network (such as Ethernet) or celled network (such as ATM). It should be noted that in this disclosure the term “packetizing” is generally used to refer to formation of packets as well as cells. Regardless of the modes of transfer, it is desirable to achieve high speeds of storage and retrieval. While the host computer initiates storage and retrieval, the data transfer in case of storage of data flows from the host computer to the storage device. Likewise, in the case of data retrieval, data flows from the storage device to the host. It is essential that both cases are handled at least as efficiently and effectively as required by the specific system.

Data sent from a host computer intended to be stored in a networked storage unit, must move through the multiple layers of a communication mode. Such a communication model is used to create a high level data representation, and break it down to manageable chunks of information that are capable of moving through the designated physical network. Movement of data from one layer of the communication model to another results in adding or striping certain portions of information relative to the previous layer. During such a movement of data, a major challenge involves the transfer of large amounts of data from one area of the physical memory to another. Any scheme used for the movement of data should ensure that the associated utilities or equipment can access and handle the data as desired.

FIG. 1 shows the standard seven layer communication model. The first two layers, the physical (PHY) layer and the media access control (MAC) layer deal with access to the physical network hardware. The also generate the basic packet forms. Data then moves up the various other layers of the communication model until the packets are delineated into usable portions of data in the application layer for use by the host computer. Similarly, when data needs to be sent from the host computer on the network, the data is moved down the communication model layers, broken on the way to smaller chunks of data, eventually creating the data packets that are handled by the MAC and PHY layers for the purpose of transmitting the data over the network.

In the communication model shown in FIG. 1, each lower layer performs tasks under the direction of the layer immediately above it in order to function correctly. A more detailed description can be found in “Computer Networks” (3^{rd} edition) by Andrew S. Tanenbaum incorporated herein by reference. In a conventional hardware solution called the FiberChannel, (FC), some of the lower level layers previously handled in software are handled in hardware. However, FC is less attractive than the commonly used Ethernet/IP technology. Ethernet/IP provides for lower cost of ownership, easier management, better interoperability among equipment from various vendors, and better sharing of data and storage resources in comparison with a comparable FC implementation. Furthermore, FC is also optimized for transferring large blocks of data and not for the more common dynamic low-latency interactive use.

As the data transfer demands from networks increase it would be advantageous to reduce at least one of the bottlenecks associated with the movement of data over the network. More specifically, it would be advantageous to reduce the amount of data movement within the memory until the data is packetized, or until the data is delineated into useable information by the host.

### II. SUMMARY

The disclosed teachings are aimed at realizing the advantages noted above.

According to an aspect of the disclosed teachings, there is provided a networked system comprising a host computer. A data streamer is connected to the host computer. The data streamer is capable of transferring data between the host and networked resources using a memory location without moving the data within the memory location. A communication link connects the data streamer and networked resources.

In a specific enhancement, the communication link is a dedicated communication link.

In another specific enhancement, the host computer is used solely for initializing the computer.

In another specific enhancement the networked resources include networked storage devices.

More specifically, the dedicated communication link is a network communication link.

Still more specifically, the dedicated communication link is selected from a group consisting of personal computer interface (PCI), PCI-X, 3GIO, InfiniBand, SPI-3, or SPI-4.

Even more specifically, wherein the network communication link is a local area network (LAN) link.

Even more specifically, wherein the network communication link is Ethernet based.

Even more specifically, the network communication link is a wide area network (WAN).

Even more specifically, the network communication link uses an Internet protocol (IP).

Even more specifically, the network communication link uses an asynchronous transfer mode (ATM) protocol.

In another specific enhancement, the data streamer further comprises at least one host interface, interfacing with said host computer; at least one network interface, interfaces with the networked resources; at least one processing node that is capable of generating additional data and commands necessary for network layer operations; an admission and classification unit that initially processes the data; an event queue manager that supports processing of the data; a scheduler that supports processing of the data; a memory manager that manages the memory; a data interconnect unit that receives the data from said admission and classification unit; and a control hub.

Specifically, the processing node is further connected to an expansion memory.

Even more specifically, the expansion memory is a code memory.

Even more specifically, the processing node is a network event processing node.

Even more specifically, the network event processing node is a packet processing node.

Even more specifically, the network event processing node is a header processing node.

Even more specifically, the host interface is selected from a group consisting of PCI, PCI-X, 3GIO, InfiniBand, SPI-3, and SPI-4.

Even more specifically, the network interface is Ethernet.

Even more specifically, the network interface is ATM.

Even more specifically, the host interface is combined with the network interface.

Even more specifically, the event queue manager is capable of managing at least: an object queue; an application queue.

Even more specifically, the object queue points to a first descriptor while first header is processed.

Even more specifically, the header processed is in the second communication layer.

Even more specifically, the header processed is in the third communication layer.

Even more specifically, the header processed is in the fourth communication layer.

Even more specifically, the object queue points to a second descriptor if the second header has the same tuple corresponding to the first header.

Even more specifically, the object queue holds at least the start address to the header information.

Even more specifically, the object queue holds at least the end address to the header information.

Even more specifically, the application queue points to said descriptor instead of said object queue if at least an application header is available.

Even more specifically, the descriptor points at least to the beginning of the application header.

Even more specifically, the application queue maintains address of said beginning of application header.

Even more specifically, the descriptor points at least to the end of said application header.

Even more specifically, the application queue maintains address of said end of application header.

Even more specifically, when all the application headers are available, data is transferred to said host in a continuous operation.

Even more specifically, the continuous operation is based on pointer information stored in said application queue.

Even more specifically, the system is adapted to receive at least one packet of data with headers from a network resource and opening a new descriptor if the headers do not belong to a previously opened descriptor.

Even more specifically, the system is adapted to store the start and end address of the headers in the object queue.

Even more specifically, the system is adapted to transfer control of the descriptor to the application queue if at least one application header is available and is further adapted to store a start and end address of the application header in the application queue.

Even more specifically, the system is adapted to transfer the data to the host based on the stored application headers.

Even more specifically, the system is adapted to receive data and a destination address from the host computer, and further wherein the system is adapted to queue the data in a transmission queue.

Even more specifically, the system is adapted to update an earlier created descriptor to point to a portion of the data that is to be sent next.

Even more specifically, the system is adapted to create headers and attach the portion of the data to the headers and transmit them over the network.

Another aspect of the disclosed teachings is a data streamer for use in a network, the streamer comprising at least one host interface, interfacing with said host computer; at least one network interface, interfacing with the networked resources; at least one processing node, capable of generating additional data and commands necessary for network layer operations; an admission and classification unit that initially processes the data; an event queue manager that supports processing of the data; a scheduler that supports processing of the data; a memory manager that manages the memory; a data interconnect unit that receives the data from said admission and classification unit; and a control hub.

Yet another aspect of the disclosed teachings is a method for transferring application data from a network to a host computer comprising: receiving headers of data from a network resource; opening a new descriptor if the headers do not belong to a previously opened; storing a start address and an end address of the headers in an object queue; transferring control of the descriptor to an application queue if at least one application header is available; storing start and end address of the application header in an application queue; repeating the steps until all application headers are available; and transferring the data to said host based on said application headers.

Still another aspect of the disclosed teachings is a method for transferring application data from a host computer to a network resource comprising: receiving data from the host computer; receiving destination address from the host computer; queuing a transmission information in a transmission queue; updating a descriptor pointing to portion of the application data to be sent next; creating headers for the transmission; attaching the portion of the application data to the headers; transmitting the portion of the application data and headers over the network; repeating until all of the application data is sent; and indicating to the host computer that transfer is complete.

### III. BRIEF DESCRIPTION OF THE DRAWINGS

The above objectives and advantages of the disclosed teachings will become more apparent by describing in detail preferred embodiments thereof with reference to the attached drawings in which:

FIG. 1 is a diagram of the conventional standard seven layer communication model.

FIG. 2 is a schematic block diagram of an exemplary embodiment of a data streamer according to the disclosed teachings.

FIG. 3 is a schematic block diagram of an exemplary networked system with a data streamer according to the disclosed teachings.

FIG. 4 shows the process of INGRESS of application data.

FIG. 5A-I demonstrate an example implementation of the technique for managing application data according to the disclosed teachings.

FIG. 6 shows the process of EGRESS of application data.

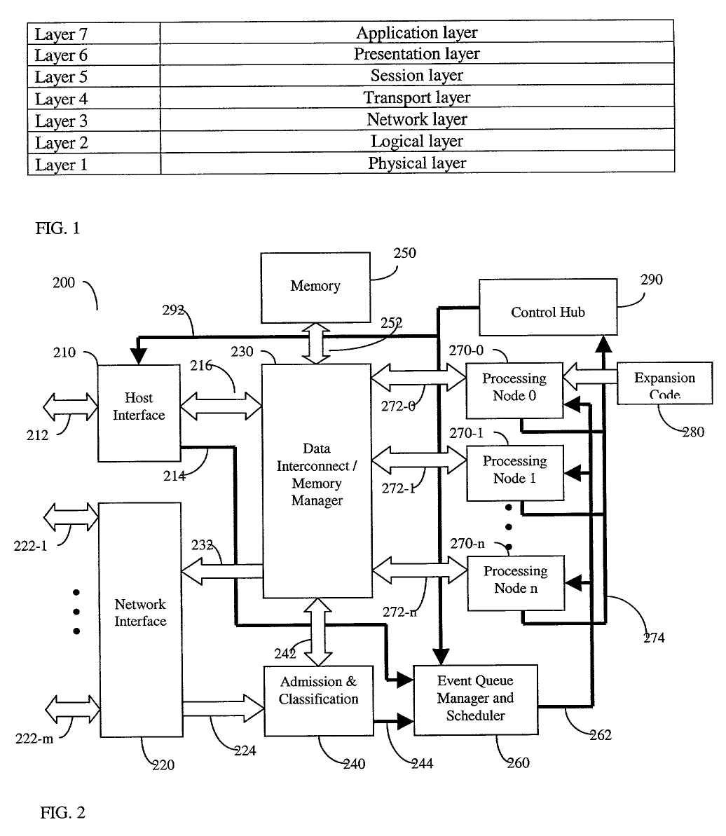

### IV. DETAILED DESCRIPTION

FIG. 2 shows a schematic diagram of an exemplary embodiment of a data streamer according to the disclosed teachings. The Data streamer (DS) 200 may be implemented as a single integrated circuit, or a circuit built of two or more circuit components. Elements such as memory 250 and expansion code 280 could be implemented using separate components while most other components could be integrated onto a single IC. Host interface (HI) 210 connects the data streamer to a host computer. The host computer is capable of receiving and sending data to DS 200 as well as sending high level commands instructing DS 200 to perform a data storage or data retrieval. Data and commands are sent to and from the host over host bus (HB) 212 connected to the host interface (HI) 210. HB 212 may be standard interfaces such as the peripheral component interconnect (PCI), but is not limited to such standards. It could also use proprietary interfaces that allow for the communication between a host computer and DS 200. Another standard that could be used is PCI-X which is a successor to the PCI bus, and which has significantly faster data rate. Yet another alternate implementation if the data streamer could use the 3GIO bus, providing an even higher performance than the PCI-X bus. In yet another alternate implementation a System Packet Interface Level 3 (SPI-3) or a System Packet Physical Interface Level 4 (SPI-4) may be used. In still another alternate implementation, an InfiniBand bus may be used.

Data received from the host computer is transferred by HI 210 over bus 216 to Data Interconnect and Memory Manager (DIMM) 230 while commands are transferred to the Event Queue Manager and Scheduler (EQMS) 260. Data received from the host computer will be stored in memory 250 awaiting further processing. Such a processing of data arriving from the host computer is performed under the control of DIMM 230, control hub (CH) 290, and EQMS 260. The data is then processed in one of the processing nodes (PN) 270. The processing nodes are network processors capable of handling the interface necessary for generating the data and commands necessary for the network layer operation. At least one processing node could be a network event processing node. Specifically, the network event processing node could be a packet processing node or a header processing node.

After processing, the data is transferred to the network interface (NI) 220. The NI 220, which depending on the type of interface to be connected to as well as destination, routes the data in its network layer format through busses 222. Busses 222 may be Ethernet, ATM, or any other proprietary or standard networking interface. A PN 270 may handle one or more types of communication interfaces depending on its embedded code, and in certain cases, can be expanded using an expansion code (EC) memory 280.

DS 200 is further capable of handling data sent over the network and targeted to the host connected to DS 200 through HB 212. Data received on any one of the NI 222 is routed through NI 220 and is processed initially through the admission and classification (AC) unit 240. Data is transferred to DIMM 230 and the control is transferred to EQMS 260. DIMM 230 places the data in memory 250 for further processing under the control of EQMS 260, DIMM 230, and HC 290. The functions of DIMM 230, EQMS 260 and CH 290 are described herein.

It should be noted that the primary function of the DIMM 230 is to control memory 250 and manage all data traffic between memory 250 and other units of DS 200, for example, data traffic involving HI 210 and NI 220. Specifically, DIMM 230 aggregates all the service requests directed to memory 250. It should be further noted that the function of EQMS 260 is to control the operation of PNs 270. EQMS 260 receives notification of the arrival of network traffic, otherwise referred to as events, via CH 290. EQMS 260 prioritizes and organizes the various events, and dispatches events to the required PN 270 when all the data for the event is available in local memory of the respective PN 270. The function of CH 290 is to handle the control messages (as opposed to data messages) transferred between units of DS 200. For example, a PN 270 may send a control message that is handled by CH 290 that creates the control packet which is then send to the desired destination. The use of these and other units of DS 200 will be further clear from the description of their use in conjunction with the methods described below.

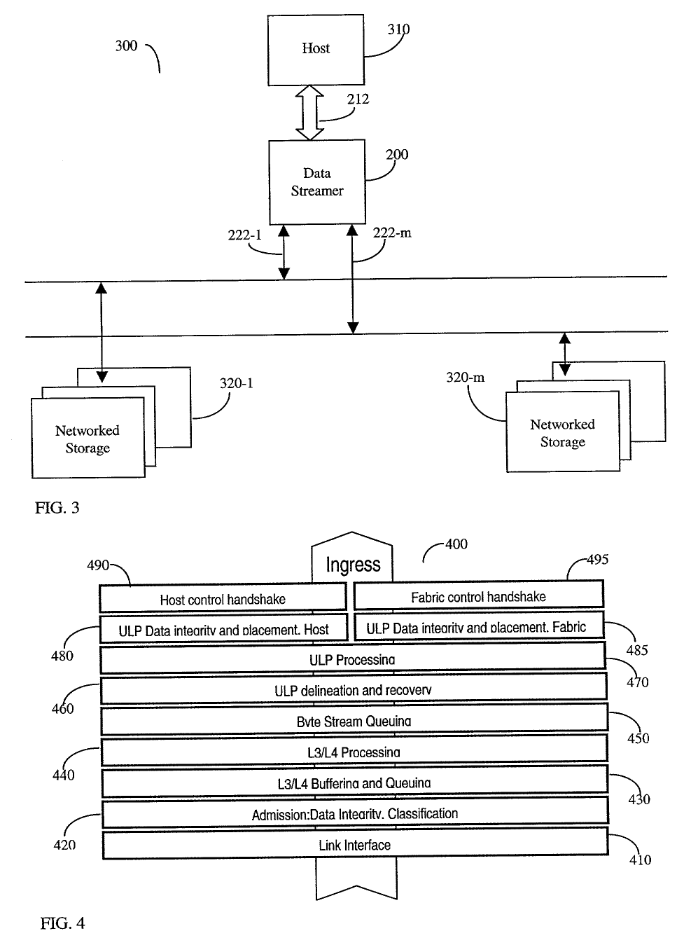

FIG. 3 shows a schematic diagram of an exemplary network system 300, according to the disclosed teachings, in which DS 200 is used. DS 200 is connected to host 310 by means of HB 212. When host 310 needs to read data from networked storage, commands are sent through HB 212 to DS 200. DS 200 processes the “read” request and handles the retrieval of data from networked storage (NS) 320 efficiently. As data is received from NS 320 in basic network blocks, they are assembled efficiently in memory 250 corresponding to DS 200. The assembly of data into the requested read information is performed without moving the data, but rather through a sophisticated pointing system, explained in more detail below.

Specifically, instead of porting, or moving data, from one place in memory to the other, as it is moved along the communication model, pointers are used to point to the data that is required at each level of the communication model. Similarly, when host 310 instructs DS 200 to write data into NS 320, DS 200 handles this request by storing the data in memory 250, and handling the sifting down through the communication model without actually moving the data within the memory 250. This results in a faster operation. Further, there is less computational burden on the host, as well as substantial saving in memory usage.

While host 310 is shown to be connected to data streamer 200 by means of HB 212, it is possible to connect host 310 to data streamer 200 by using one of the network interface 222 that is capable of supporting the specific communication protocol used to communicate with host 310. In another alternate implementation of the disclosed technique, host 310 is used only for configuring the system initially. Thereafter, all operations are executed over network 222.

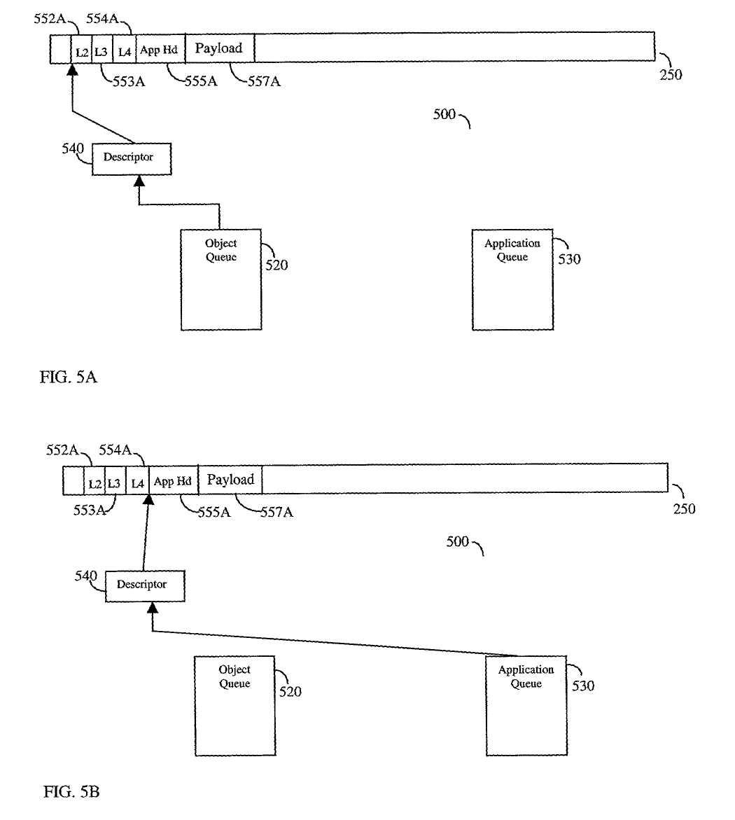

FIG. 4 schematically describes the process of ingress 400, illustrating schematically the data flow from the network to the system. In each step, the data (originally received as a stream of packets) is consolidated or delineated into a meaningful piece of information to be transferred to the host. The ingress steps for data framing include the link interface 410, provided by NI 220, admission 420, provided by AC 240, buffering and queuing 430, provided by DIMM 230 and EQMS 260, layer 3 and layer 4 processing 440, provided by PNs 270, byte stream queuing 450, provided by EQMS 260. Upper Layer Protocol (ULP) delineation and recovery 460 and ULP processing 470 are further supported by PNs 270. Various other control and handshake activities designated to transfer the data to the host 480, 490, are provided by HI 210 and bus 212, while activities designated to transfer the data to the network 485, 495 are supported by NI 220 and interface 222. It should be further noted the CH 290 is involved in all steps of Ingress 400.

ULP corresponds to protocols for the 5th, 6th and 7th layer of the seven layer communication model. All this activity is performed by data streamer 200. A factor contributing to the efficiency of the disclosed teachings is the management of the delineation of data in a manner that does not require movement of data as in conventional techniques.

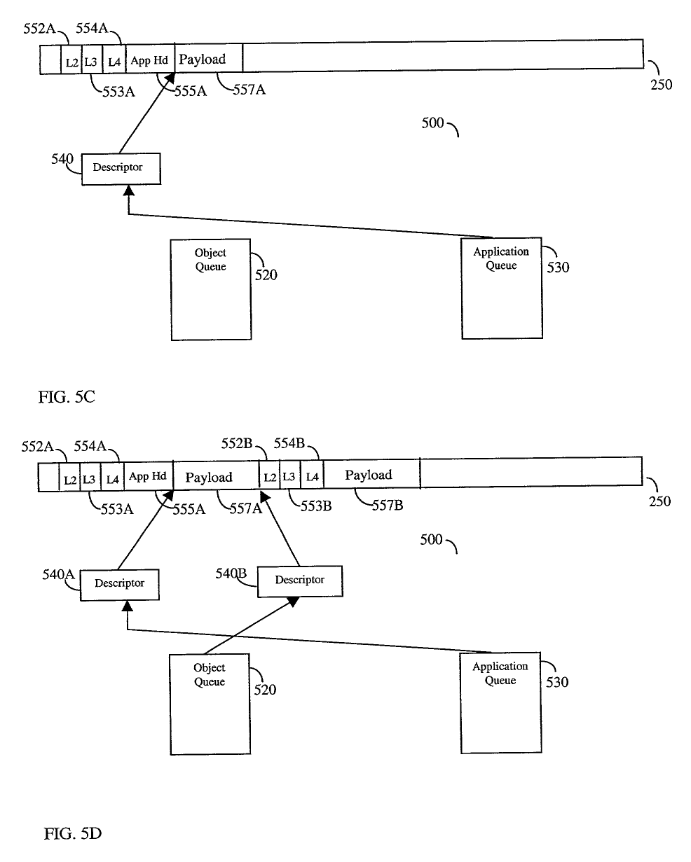

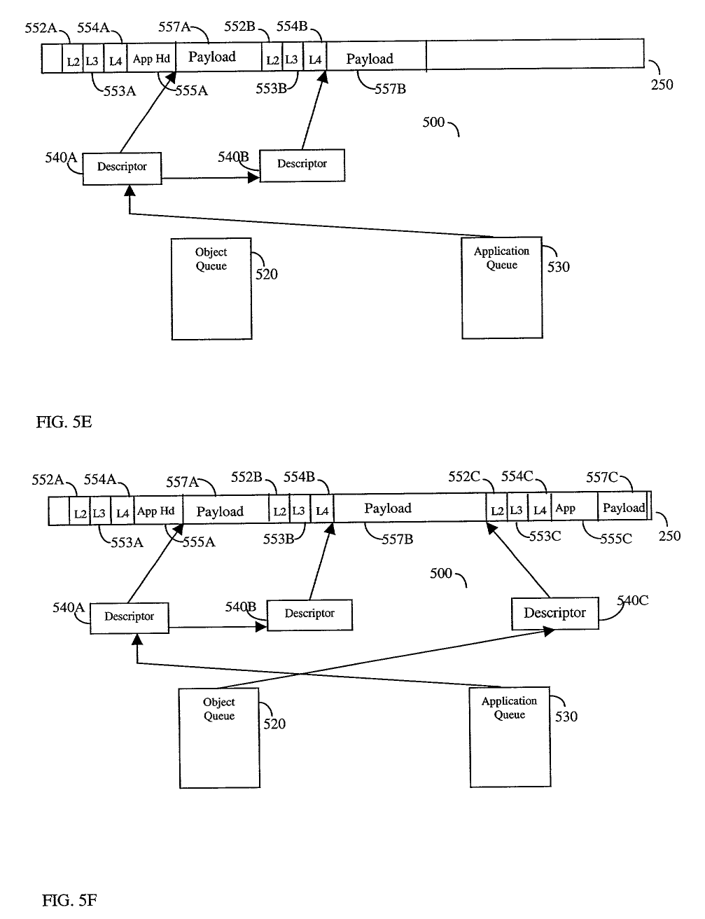

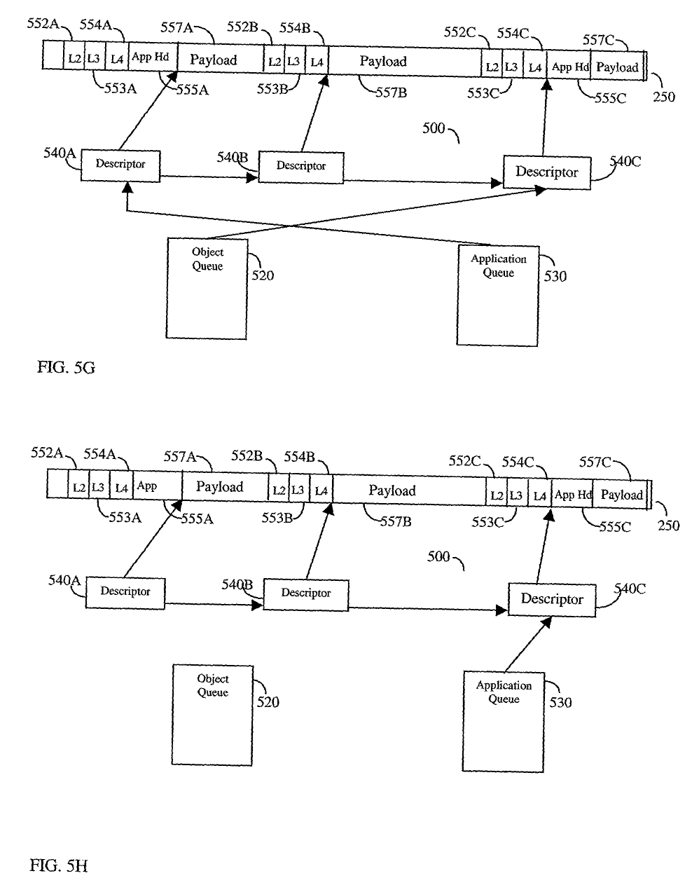

FIG. 5 shows the techniques used to access data delineated from the payload data received from each packet. When a packet belonging to a unique process is received, as identified by its unique tuple, an object queue and an application queue are made available, by EQMS 260 on PNs 270. This is demonstrated in FIG. 5A, where as a result of an arrival of a packet of data an object queue 520 is provided as well as a descriptor pointer 540. Descriptor pointer 540 points to location 552A, in memory 250, where the header relative to layer 2 of the packet is placed. This is repeated for the headers relative to layer 3 and layer 4. They are placed at locations 553A and 554A respectively. The application header is then placed in 555A. This activity is performed by means of DIMM 230.

In conjunction with opening object queue 520, an application queue 530 is also made available for the use of all the payload relevant to the process flow. The pointer contained in descriptor 540 is advanced each time the information relative to the communication layers is accepted, so that such header is placed in 552A, 553A, 554A and 555A is available for future retrieval. A person skilled in the art could easily implement a queue (or other similar data structures) for the purpose of retrieval of such data.

In FIG. 5B system 500 is shown when it has received all the information from layers 2, 3 and 4, and ready to accept the application header respective to the packet. Therefore, control over descriptor 540 is transferred to application queue 530. Application queue 530 maintains information related to the start address (in the memory 250) of the application header.

In FIG. 5C, system 500 is shown once it has received the application header. The descriptor 540 now points to where the payload 557A is to be placed as it arrives. Data is transferred to memory 250 via DIMM 230, under the control of PN 270 and CH 290. There is no pointer at this point to the end of the payload, as it has not yet been received. Once the useful payload data, that will be eventually sent to the host, is available, the pointer will be updated. The start and end pointers to the application data are kept in the application queue ensuring that when the data is to be transferred to the host it is easily located. Moreover, no data movement from one part of memory to another is required hence saving time and memory space, resulting in an overall higher performance.

FIG. 5D shows another packet that is accepted and hence a new descriptor pointer 540B is provided that has a pointer from object queue 520. Initially, descriptor 540B points to the beginning address of the second layer 552B location.

In FIG. 5E the information of layers 2, 3 and 4 has already been received, and the tuple is identified by the system as belonging to the same tuple of a packet previously received. Therefore, decriptor 540A points now to descriptor 540B, and descriptor 540B points to the end address of the fourth layer information stored in memory 250. In the case described in this example there is no application header which is a perfectly acceptable situation. It should be noted that while all packets have a payload, not all packets have an application header as shown in this case. In the example shown in FIG. 5 the first packet has an application header, the second packet does not have application header, and the third packet does have an application header. All three packets do have a payload.

When another packet is received, as shown in FIG. 5F, a new descriptor pointer 540C is added, pointing to the initial location for the gathering of header information of layers 2, 3, 4, and a potential application header, in memory 250.

In FIG. 5G the information of layers 2, 3, 4, and application header, 552C, 553C, 554C and 555C respectively, is stored in memory 250, under control of DIMM 230, and the tuple identified as belonging to the same packets previously received. Therefore, descriptor 540B points to descriptor 540C.

As shown in FIG. 5H, this packet contains an application header and hence descriptor 540C points to the starting address for the placement of this header in memory 250, while FIG. 5I shows the situation after the entire application header is received. As explained above, the start and end addresses of the application header are stored in application queue 530 and therefore it is easy to transfer them as well as the payload host 310. In some protocols, such as iSCSI, only the data payload will be transferred to the host, in other cases ULP payload and header may be transferred to the host. Data streamer 200 may use built-in firmware, or otherwise additional code provided through expansion code 280, for the purpose of system configuration in a manner desirable for the transfer of data and headers to host 310.

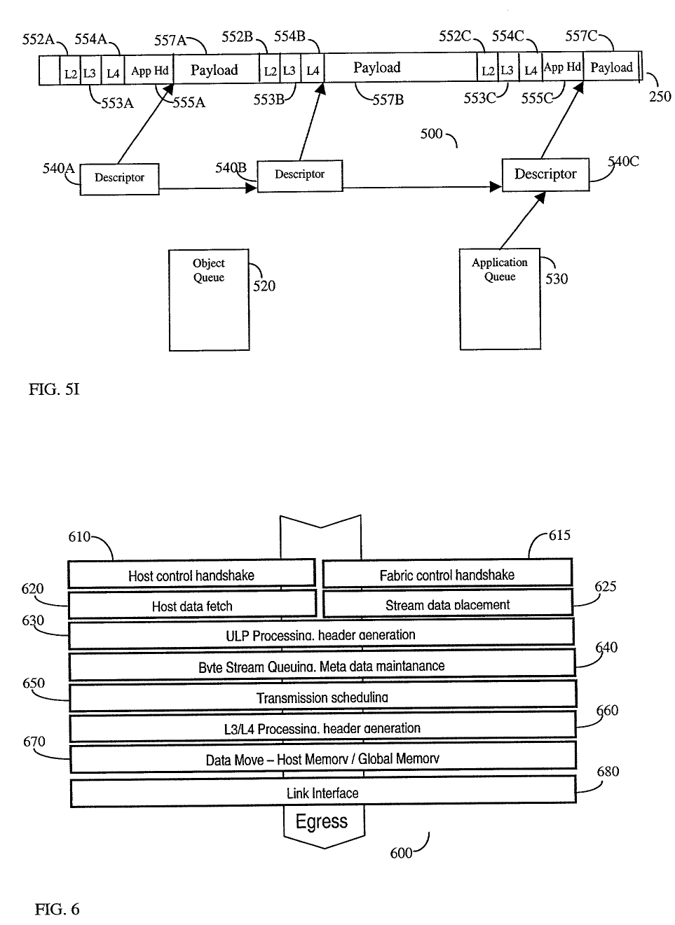

FIG. 6 shows egress 600, the process by which data is transferred from the host to the network. The application data is received from host 310 to memory 250 with an upper level request to send it to a desired network location. Data streamer 200 is designed such that it is capable of handling the host data without multiple moves of the data to correspond with each of the communication layer needs. This reduces the number of data transfers resulting in less memory requirements as well as an overall increased performance. Event queue manager and scheduler 260 manages the breakdown of the data from host 310, now stored in memory 250, into payload data attached to packet headers, as may be deemed appropriate for the specific network traffic. Using a queuing system, pointers to the data stored in memory 250 are used in order to point to an address that is the next to be used as data attached to a packet. Host 310 gets an indication of the completion of the data transfer once all the data stored in memory is sent to its destination.

Other modifications and variations to the invention will be apparent to those skilled in the art from the foregoing disclosure and teachings. Thus, while only certain embodiments of the invention have been specifically described herein, it will be apparent that numerous modifications may be made thereto without departing from the spirit and scope of the invention.

What is claimed is:

1. A networked system comprising:
a host computer;
a data streamer connected to said host computer, said data streamer capable of transferring data between said host and networked resources using a memory location without moving the data within the memory location;
a communication link connecting said data streamer and networked resources.

2. The system of claim 1, wherein said communication link is a dedicated communication link.

3. The system of claim 1, wherein said host computer is used solely for initializing the computer.

4. The system of claim 1, wherein the networked resources include networked storage devices.

5. The system of claim 2, wherein the dedicated communication link is a network communication link.

6. The system of claim 3, wherein the dedicated communication link is selected from a group consisting of personal computer interface (PCI), PCI-X, 3GIO, InfiniBand, SPI-3, or SPI-4.

7. The system of claim 5, wherein the network communication link is a local area network (LAN) link.

8. The system of claim 5, wherein the network communication link is Ethernet based.

9. The system of claim 5, wherein the network communication link is a wide area network (WAN).

10. The system of claim 5, wherein the network communication link uses an Internet protocol (IP).

11. The system of claim 5, wherein the network communication link uses an asynchronous transfer mode (ATM) protocol.

12. The system of claim 1, wherein said data streamer further comprises:
at least one host interface, interfacing with said host computer;
at least one network interface, interfacing with the networked resources;
at least one processing node, capable of generating additional data and commands necessary for network layer operations;
an admission and classification unit that initially processes the data;
an event queue manager that supports processing of the data;
a scheduler that supports processing of the data;
a memory manager that manages the memory;
a data interconnect unit that receives the data from said admission and classification unit; and
a control hub.

13. The system of claim 12, wherein said processing node is further connected to an expansion memory.

14. The system of claim 13, wherein said expansion memory is a code memory.

15. The system of claim 12, wherein said processing node is a network event processing node.

16. The system of claim 15, wherein said network event processing node is a packet processing node.

17. The system of claim 15, wherein said network event processing node is a header processing node.

18. The system of claim 12, wherein said host interface is selected from a group consisting of PCI, PCI-X, 3GIO, InfiniBand, SPI-3, and SPI-4.

19. The system of claim 12, wherein the network interface is Ethernet.

20. The system of claim 12, wherein the network interface is ATM.

21. The system of claim 12, wherein said host interface is combined with the network interface.

22. The system of claim 12, wherein said event queue manager is capable of managing at least:
an object queue; and
an application queue.

23. The system of claim 22, wherein said object queue points to a first descriptor while first header is processed.

24. The system of claim 23, wherein the header processed is in the second communication layer.

25. The system of claim 23, wherein the header processed is in the third communication layer.

26. The system of claim 23, wherein the header processed is in the fourth communication layer.

27. The system of claim 23, wherein said object queue points to a second descriptor if the second header has the same tuple corresponding to the first header.

28. The system of claim 22, wherein said object queue holds at least the start address to the header information.

29. The system of claim 22, wherein said object queue hold at least the end address to the header information.

30. The system of claim 23, wherein said application queue points to said descriptor instead of said object queue if at least an application header is available.

31. The system of claim 23, wherein said descriptor points at least to the beginning of the application header.

32. The system of claim 31, wherein said application queue maintains address of said beginning of application header.

33. The system of claim 23, wherein said descriptor points at least to the end of said application header.

34. The system of claim 33, wherein said application queue maintains address of said end of application header.

35. The system of claim 30, wherein when all the application headers are available, data is transferred to said host in a continuous operation.

36. The system of claim 35, wherein said continuous operation is based on pointer information stored in said application queue.

37. The system of claim 22, wherein the system is adapted to receive at least one packet of data with headers from a network resource and opening a new descriptor if the headers do not belong to a previously opened descriptor.

38. The system of claim 37, wherein the system is adapted to store the start and end address of the headers in the object queue.

39. The system of claim 37, wherein the system is adapted to transfer control of the descriptor to the application queue if at least one application header is available and is further adapted to store a start and end address of the application header in the application queue.

40. The system of claim 39, wherein the system is adapted to transfer the data to the host based on the stored application headers.

41. The system of claim 22, wherein the system is adapted to receive data and a destination address from the host computer, and further wherein the system is adapted to queue the data in a transmission queue.

42. The system of claim 41, wherein the system is adapted to update an earlier created descriptor to point to a portion of the data that is to be sent next.

43. The system of claim 42, wherein the system is adapted to create headers and attach the portion of the data to the headers and transmit them over the network.

44. A data streamer for use in a network, said streamer comprising:
at least one host interface, interfacing with said host computer;
at least one network interface, interfacing with the networked resources;
at least one processing node, capable of generating additional data and commands necessary for network layer operations;
an admission and classification unit that initially processes the data;
an event queue manager that supports processing of the data;
a scheduler that supports processing of the data;
a memory manager that manages the memory;
a data interconnect unit that receives the data from said admission and classification unit; and
a control hub.

45. The streamer of claim 44, wherein said processing node is further connected to an expansion memory.

46. The streamer of claim 45, wherein said expansion memory is a code memory.

47. The streamer of claim 44, wherein said processing node is a network event processing node.

48. The streamer of claim 47, wherein said network event processing node is a packet processing node.

49. The streamer of claim 47, wherein said network event processing node is a header processing node.

50. The streamer of claim 44, wherein said host interface is selected from a group consisting of PCI, PCI-X, 3GIO, InfiniBand, SPI-3, and SPI-4.

51. The streamer of claim 44, wherein the network interface is Ethernet.

52. The streamer of claim 44, wherein the network interface is ATM.

53. The streamer of claim 44, wherein said host interface is combined with the network interface.

54. The streamer of claim 44, wherein said event queue manager is capable of managing at least:
an object queue;
an application queue.

55. The streamer of claim 54, wherein said object queue points to a first descriptor while first header is processed.

56. The streamer of claim 55, wherein the header processed is in the second communication layer.

57. The streamer of claim 55, wherein the header processed is in the third communication layer.

58. The streamer of claim 55, wherein the header processed is in the fourth communication layer.

59. The streamer of claim 55, wherein said object queue points to a second descriptor if the second header has the same tuple corresponding to the first header.

60. The streamer of claim 54, wherein said object queue hold at least the start address to the header information.

61. The streamer of claim 54, wherein said object queue hold at least the end address to the header information.

62. The streamer of claim 55, wherein said application queue points to said descriptor instead of said object queue if at least an application header is available.

63. The streamer of claim 55, wherein said descriptor points at least to the beginning of the application header.

64. The streamer of claim 63, wherein said application queue maintains address of said beginning of application header.

65. The streamer of claim 55, wherein said descriptor points at least to the end of said application header.

66. The streamer of claim 65, wherein said application queue maintains address of said end of application header.

67. The streamer of claim 62, wherein when all the application headers are available, data is transferred to said host in a continuous operation.

68. The streamer of claim 67, wherein said continuous operation is based on pointer information stored in said application queue.

69. The streamer of claim 54, wherein the streamer is adapted to receive at least one packet of data with headers from a network resource and opening a new descriptor if the headers do not belong to a previously opened descriptor.

70. The streamer of claim 69, wherein the streamer is adapted to store the start and end address of the headers in the object queue.

71. The streamer of claim 70, wherein the streamer is adapted to transfer control of the descriptor to the application queue if at least one application header is available and is further adapted to store a start and end address of the application header in the application queue.

72. The streamer of claim 71, wherein the streamer is adapted to transfer the data to the host based on the stored application headers.

73. The streamer of claim 54, wherein the streamer is adapted to receive data and a destination address from the host computer, and further wherein the streamer is adapted to queue the data in a transmission queue.

74. The streamer of claim 73, wherein the streamer is adapted to update an earlier created descriptor to point to a portion of the data that is to be sent next.

75. The streamer of claim 74, wherein the streamer is adapted to create headers and attach the portion of the data to the headers and transmit them over the network.

76. A method for transferring application data from a network to a host computer comprising:
a) receiving headers of data from a network resource;
b) opening a new descriptor if the headers do not belong to a previously opened;
c) storing a start address and an end address of the headers in an object queue;
d) transferring control of the descriptor to an application queue if at least one application header is available;
e) storing start and end address of the application header in an application queue;
f) repeating steps a through e) until all application headers are available; and
g) transferring the data to said host based on said application headers.

77. A method for transferring application data from a host computer to a network resource comprising:
a) receiving data from the host computer;
b) receiving destination address from the host computer;
c) queuing a transmission information in a transmission queue;
d) updating a descriptor pointing to portion of the application data to be sent next;
e) creating headers for the transmission;
f) attaching the portion of the application data to the headers;
g) transmitting the portion of the application data and headers over the network;
h) repeating steps d through g until all of the application data is sent; and
i) indicating to the host computer that transfer is complete.
